(19) United States
(12) Patent Application Publication
(10) Pub. No.: US 2023/0135332 A1
(43) Pub. Date: May 4, 2023

(54) METHOD AND DEVICE FOR DIRECT COMMUNICATION IN WIRELESS LAN SYSTEM

(71) Applicants: HYUNDAI MOTOR COMPANY, Seoul (KR); KIA CORPORATION, Seoul (KR); KOREA NATIONAL UNIVERSITY OF TRANSPORTATION INDUSTRY-ACADEMIC COOPERATION FOUNDATION, Chungju-si (KR)

(72) Inventor: Yong Ho Kim, Incheon (KR)

(73) Assignees: HYUNDAI MOTOR COMPANY, Seoul (KR); KIA CORPORATION, Seoul (KR); KOREA NATIONAL UNIVERSITY OF TRANSPORTATION INDUSTRY-ACADEMIC COOPERATION FOUNDATION, Chungju-si (KR)

(21) Appl. No.: 17/918,851

(22) PCT Filed: Apr. 13, 2021
(86) PCT No.: PCT/KR2021/004658

§ 371 Date: Oct. 13, 2022

(30) Foreign Application Priority Data
Apr. 14, 2020 (KR) 10-2020-0045329

(51) Int. Cl. H04W 74/08

(52) U.S. Cl. CPC H04W 74/0816; H04W 74/0866; H04W 84/12

(57) ABSTRACT

A method and a device are disclosed for direct communication in a wireless local area network (LAN) system. An operation method of an access point comprises the steps of: transmitting a first frame including time information of a first communication period to a first station in order to configure the first communication period; receiving, from the first station, a second frame that is a response frame to the first frame, and configuring the first communication period; and after receiving the second frame, transmitting a third frame including time information of a second communication period to a second station in order to configure the second communication period within the first communication period.

### CROSS-REFERENCE TO RELATED APPLICATIONS

This application is a U.S. national stage of International Application No. PCT/KR2021/004658, filed on Apr. 13, 2021, which claims priority to Korean Patent Application No. 10-2020-0045329 filed on Apr. 14, 2020, the entire disclosures of which are incorporated by reference herein in its entirety.

### TECHNICAL FIELD

The present disclosure relates to a wireless local area network (LAN) communication technique, and more particularly, to a technique for direct communication between stations.

### BACKGROUND

Recently, as the spread of mobile devices expands, a wireless local area network technology capable of providing fast wireless communication services to mobile devices is in the spotlight. The wireless local area network (LAN) technology may be a technology that supports mobile devices such as smart phones, smart pads, laptop computers, portable multimedia players, embedded devices, and the like to wirelessly access the Internet based on wireless communication technology.

The standards using the wireless LAN technology are being standardized as IEEE802.11 standards mainly in the Institute of Electrical and Electronics Engineers (IEEE). The initial version of the IEEE 802.11 standard can support a communication speed of 1 to 2 megabits per second (Mbps). The later versions of the IEEE 802.11 standard are being standardized in the direction of improving the communication speed.

The revised version of the IEEE 802.11a standard can support a communication speed of up to 54 Mbps using an orthogonal frequency division multiplexing (OFDM) scheme in a 5 giga hertz (GHz) band. The IEEE 802.11b standard utilizes a direct sequence spread spectrum (DSSS) scheme to support a communication speed of up to 11 Mbps in a 2.4 GHz band where the initial version operates.

The IEEE 802.1 In standard supporting a high throughput (HT) wireless LAN technology has been developed due to the demand for higher speed. The IEEE 802.11n standard may support the OFDM scheme. By supporting channel bandwidth expansion techniques and multiple input multiple output (MIMO) techniques in the IEEE 802.11n standard, the maximum communication speeds in the 2.4 GHz band and the 5 GHz band can be improved. For example, the IEEE 802.11n standard can support a communication speed of up to 600 Mbps by using 4 spatial streams and a 40 MHz bandwidth.

As the above-described wireless LAN technologies have been developed and spread, applications using the wireless LAN technologies have been diversified, and a demand for a wireless LAN technology supporting a higher throughput has arisen. Accordingly, a frequency bandwidth (e.g., ‘maximum 160 MHz bandwidth’ or ‘80+80 MHz bandwidth’) used in the IEEE 802.11ac standard has been expanded, and the number of supported spatial streams has also increased. The IEEE 802.11 ac standard may be a very high throughput (VHT) wireless LAN technology supporting a high throughput of 1 gigabit per second (Gbps) or more. The IEEE 802.11ac standard can support downlink transmission for multiple stations by utilizing the MIMO techniques.

As the demand for wireless LAN technologies further increases, the IEEE 802.11ax standard has been developed to increase a frequency efficiency in a dense environment. In the IEEE 802.11 ax standard, a communication procedure may be performed using multi-user (MU) orthogonal frequency division multiple access (OFDMA) techniques. In the IEEE 802.11 ax standard, uplink communication may be performed using the MU MIMO techniques and/or OFDMA techniques.

As applications requiring higher throughput and applications requiring real-time transmission occur, the IEEE 802.11be standard, which is an extreme high throughput (EHT) wireless LAN technology, is being developed. The goal of the IEEE 802.1 1be standard may be to support a high throughput of 30 Gbps. The IEEE 802.11be standard may support techniques for reducing a transmission latency. In addition, the IEEE 802.11be standard can support a more expanded frequency bandwidth (e.g., 320 MHz bandwidth), multi-link transmission and aggregation operations including multi-band operations, multiple access point (AP) transmission operations, and/or efficient retransmission operations (e.g., hybrid automatic repeat request (HARQ) operations).

However, since the multi-link operation is an operation that is not defined in the existing WLAN standard, it may be necessary to define detailed operations according to the environment in which the multi-link operation is performed. In particular, when two or more bands performing the multi-link operation are close to each other, simultaneous transmission and reception operations through a multi-link may not be performed within one device due to signal interference between adjacent channels (e.g., adjacent links). In particular, when a signal interference level between the adjacent channels is equal to or greater than a specific level, a backoff operation for transmission in another link may not be performed due to the interference while performing a transmission operation in one link. Therefore, in the above-described situations, a method for updating parameter(s) for multi-link operations and a method for transmitting/receiving data based on the updated parameter(s) may be required. In addition, direct communication between stations may be performed in a wireless LAN system (e.g., wireless LAN system supporting a multi-link). In this case, a method for supporting the direct communication is needed.

Meanwhile, the technologies that are the background of the present disclosure are written to improve the understanding of the background of the present disclosure and may include content that is not already known to those of ordinary skill in the art to which the present disclosure belongs.

### SUMMARY

### Technical Problem

The present disclosure is directed to providing a method and an apparatus for direct communication between stations in a wireless local area network (LAN) system. Technical Solution

An operation method of an access point, according to a first embodiment of the present disclosure for achieving the above-described objective, may comprise: transmitting, to a first station, a first frame to configure a first communication period, the first frame including information on a time of the first communication period; receiving, from the first station, a second frame that is a response frame to the first frame, and configuring the first communication period; after receiving the second frame, transmitting a third frame to a second station to configure a second communication period within the first communication period, the third frame including information on a time of the second communication period; identifying that the second station transmits a fourth frame using a resource allocated by the third frame, the fourth frame being a direct communication frame transmitted to a third station that is not the access point; and identifying that the third station transmits a reception response frame for the fourth frame.

The operation method may further comprise identifying that the second station transmits a fifth frame using a resource allocated by the third frame within the second communication period after a predetermine time elapses from a transmission completion time of the reception response frame. The fifth frame may be a direct communication frame transmitted to a fourth station that is not the access point. The operation method may also comprise identifying that a reception response frame for the fifth frame is transmitted.

A direct communication period may be configured as the second communication period within the first communication period. The second communication period may be indicated by a duration field included in the third frame.

The third frame may be a trigger frame or a multi-user (MU) request-to-send (RTS) frame.

The third frame may further include resource allocation information and the fourth frame may be transmitted and received in a resource indicated by the resource allocation information.

A frame transmission/reception operation between the second station and the third station during the second communication period may be performed based on a short interframe space (SIFS) without performing a channel access procedure.

An access point, according to a second embodiment of the present disclosure for achieving the above-described objective, may comprise a processor and a memory storing one or more instructions executable by the processor. The one or more instructions are executed to: transmit, to a first station, a first frame to configure a first communication period, the first frame including information on a time of the first communication period; receive, from the first station, a second frame that is a response frame to the first frame and configure the first communication period; after receiving the second frame, transmit a third frame to a second station to configure a second communication period within the first communication period, the third frame including information on a time of the second communication period; identify that the second station transmits a fourth frame using a resource allocated by the third frame, the fourth frame being a direct communication frame transmitted to a third station that is not the access point; and identify that the third station transmits a reception response frame for the fourth frame.

The one or more instructions may be further executed to identify that the second station transmits a fifth frame using a resource allocated by the third frame within the second communication period after a predetermine time elapses from a transmission completion time of the reception response frame. The fifth frame may be a direct communication frame transmitted to a fourth station that is not the access point. The one or more instructions may be further executed to identify that a reception response frame for the fifth frame is transmitted.

A direct communication period may be configured as the second communication period within the first communication period. The second communication period may be indicated by a duration field included in the third frame.

The third frame may be a trigger frame or a multi-user (MU) request-to-send (RTS) frame.

The third frame may further include resource allocation information and the fourth frame may be transmitted and received in a resource indicated by the resource allocation information.

A frame transmission/reception operation between the second station and the third station during the second communication period may be performed based on a short interframe space (SIFS) without performing a channel access procedure. Advantageous Effects

According to the present disclosure, a relay station may perform a negotiation procedure for direct communication with an access point. The negotiation procedure for direct communication can be performed quickly and transmission efficiency can be improved accordingly. A direct communication procedure may be performed by one station. In this case, a time required for distributed access can be reduced and communication efficiency can be improved.

### DESCRIPTION OF DRAWINGS

FIG. 1 is a block diagram illustrating a first embodiment of a communication node constituting a wireless local area network (LAN) system.

FIG. 2 is a conceptual diagram illustrating a first embodiment of multi-links configured between multi-link devices (MLDs).

FIG. 3 is a sequence chart illustrating a first embodiment of a negotiation procedure for a multi-link operation in a wireless LAN system.

FIG. 4 is a conceptual diagram illustrating a first scenario in which direct communication is performed.

FIG. 5 is a timing diagram illustrating a first embodiment of a direct communication method in a wireless LAN system.

FIG. 6 is a timing diagram illustrating a second embodiment of a direct communication method in a wireless LAN system.

FIG. 7 is a timing diagram illustrating a third embodiment of a direct communication method in a wireless LAN system.

FIG. 8 is a timing diagram illustrating a fourth embodiment of a direct communication method in a wireless LAN system.

### DETAILED DESCRIPTION

Since the present disclosure may be variously modified and may have several forms, specific embodiments are shown in the accompanying drawings and are described in the detailed description. It should be understood, however, that it is not intended to limit the present disclosure to the specific embodiments. On the contrary, the present disclosure is intended to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named as a second component without departing from the scope of the present disclosure, and the second component may also be similarly named as the first component. The term “and/or” means any one or a combination of a plurality of related and described items.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it should be understood that a further component is not disposed therebetween.

The terms used in the present disclosure are only used to describe specific embodiments and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists. However, it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings consistent with contextual meanings in the art. In this description, unless defined clearly, terms are not necessarily construed as having formal meanings.

Hereinafter, forms of the present disclosure are described in detail with reference to the accompanying drawings. In describing the disclosure, to facilitate the entire understanding of the disclosure, like numbers refer to like elements throughout the description of the figures and the repetitive description thereof has been omitted.

In the following, a wireless communication system to which embodiments according to the present disclosure are applied is described. The wireless communication system to which the embodiments according to the present disclosure are applied is not limited to the contents described below, and the embodiments according to the present disclosure can be applied to various wireless communication systems. A wireless communication system may be referred to as a ‘wireless communication network’.

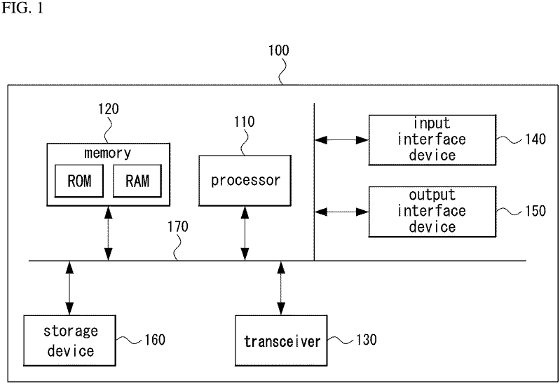

FIG. 1 is a block diagram illustrating a first embodiment of a communication node constituting a wireless local area network (LAN) system.

As shown in FIG. 1, a communication node 100 may be an access point, a station, an access point (AP) multi-link device (MLD), or a non-AP MLD. The access point may refer to an AP, and the station may refer to a STA or a non-AP STA. The operating channel width supported by the access point may be 20 megahertz (MHz), 80 MHz, 160 MHz, or the like. The operating channel width supported by the station may be 20 MHz, 80 MHz, or the like.

The communication node 100 may include at least one processor 110, a memory 120, and a plurality of transceivers 130 connected to a network to perform communications. The transceiver 130 may be referred to as a transceiver, a radio frequency (RF) unit, an RF module, or the like. In addition, the communication node 100 may further include an input interface device 140, an output interface device 150, a storage device 160, and the like. The components included in the communication node 100 may be connected by a bus 170 to communicate with each other.

However, the respective components included in the communication node 100 may be connected through individual interfaces or individual buses centering on the processor 110 instead of the common bus 170. For example, the processor 110 may be connected to at least one of the memory 120, the transceiver 130, the input interface device 140, the output interface device 150, or the storage device 160 through a dedicated interface.

The processor 110 may execute at least one instruction stored in at least one of the memory 120 or the storage device 160. The processor 110 may refer to a central processing unit (CPU), a graphics processing unit (GPU), or a dedicated processor on which the methods according to the embodiments of the present invention are performed. Each of the memory 120 and the storage device 160 may be configured as at least one of a volatile storage medium or a nonvolatile storage medium. For example, the memory 120 may be configured with at least one of a read only memory (ROM) or a random access memory (RAM).

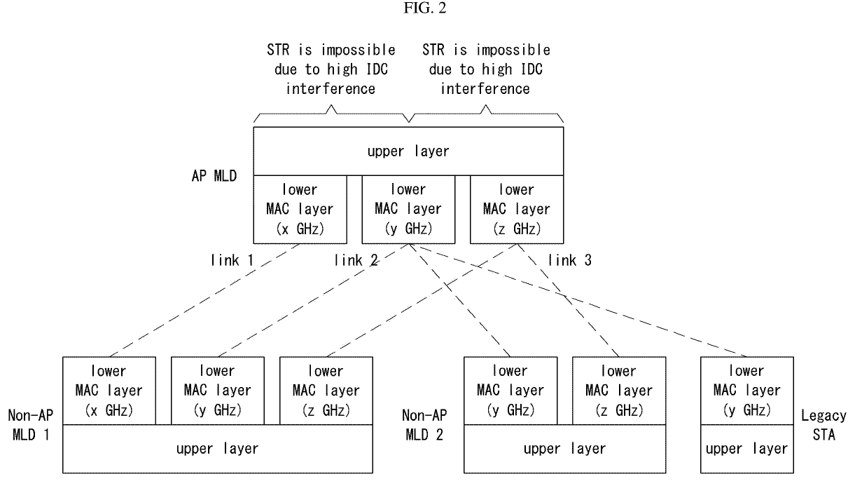

FIG. 2 is a conceptual diagram illustrating a first embodiment of multi-links configured between MLDs.

As shown in FIG. 2, an MLD may have one medium access control (MAC) address. In embodiments, the MLD may mean an AP MLD and/or non-AP MLD. The MAC address of the MLD may be used in a multi-link setup procedure between the non-AP MLD and the AP MLD. The MAC address of the AP MLD may be different from the MAC address of the non-AP MLD. AP(s) affiliated with the AP MLD may have different MAC addresses, and station(s) (STA(s)) affiliated with the non-AP MLD may have different MAC addresses. Each of the APs having different MAC addresses may be in charge of each link among multiple links supported by the AP MLD and may perform a role of an independent AP.

Each of the STAs having different MAC addresses may be in charge of each link among multiple links supported by the non-AP MLD and may perform a role of an independent STA. The non-AP MLD may be referred to as a STA MLD. The MLD may support a simultaneous transmit and receive (STR) operation. In this case, the MLD may perform a transmission operation in a link 1 and may perform a reception operation in a link 2. The MLD supporting the STR operation may be referred to as an STR MLD (e.g., STR AP MLD, STR non-AP MLD). In embodiments, a link may mean a channel or a band. A device that does not support the STR operation may be referred to as a non-STR (NSTR) AP MLD or an NSTR non-AP MLD (or NSTR STA MLD).

The MLD may transmit and receive frames in multiple links (i.e., multi-link) by using a non-contiguous bandwidth extension scheme (e.g., 80 MHz + 80 MHz). The multi-link operation may include multi-band transmission. The AP MLD may include a plurality of APs, and the plurality of APs may operate in different links. Each of the plurality of APs may perform function(s) of a lower MAC layer. Each of the plurality of APs may be referred to as a ‘communication node’ or ‘lower entity’. The communication node (i.e., AP) may operate under control of an upper layer (or the processor 110 shown in FIG. 1). The non-AP MLD may include a plurality of STAs, and the plurality of STAs may operate in different links. Each of the plurality of STAs may be referred to as a ‘communication node’ or ‘lower entity’. The communication node (i.e., STA) may operate under control of an upper layer (or the processor 110 shown in FIG. 1).

The MLD may perform communications in multiple bands (i.e., multi-band). For example, the MLD may perform communications using an 80 MHz bandwidth according to a channel expansion scheme (e.g., bandwidth expansion scheme) in a 2.4 GHz band and may perform communications using a 160 MHz bandwidth according to a channel expansion scheme in a 5 GHz band. The MLD may perform communications using a 160 MHz bandwidth in the 5 GHz band and may perform communications using a 160 MHz bandwidth in a 6 GHz band. One frequency band (e.g., one channel) used by the MLD may be defined as one link. Alternatively, a plurality of links may be configured in one frequency band used by the MLD. For example, the MLD may configure one link in the 2.4 GHz band and two links in the 6 GHz band. The respective links may be referred to as a first link, a second link, and a third link. Alternatively, the respective links may be referred to as a link 1, a link 2, and a link 3. A link number may be set by the AP, and an identifier (ID) may be assigned to each link.

The MLD (e.g., AP MLD and/or non-AP MLD) may configure a multi-link by performing an access procedure and/or a negotiation procedure for a multi-link operation. In this case, the number of links and/or link(s) to be used in the multi-link may be configured. The non-AP MLD (e.g., STA) may identify information on band(s) capable of communicating with the AP MLD. In the negotiation procedure for a multi-link operation between the non-AP MLD and the AP MLD, the non-AP MLD may configure one or more links among links supported by the AP MLD to be used for the multi-link operation. A station that does not support a multi-link operation (e.g., IEEE 802.11a/b/g/n/ac/ax STA) may be connected to one or more links of the multi-link supported by the AP MLD.

When a band separation between multiple links (e.g., a band separation between the link 1 and the link 2 in the frequency domain) is sufficient, the MLD may perform an STR operation. For example, the MLD may transmit a physical layer convergence procedure (PLCP) protocol data unit (PPDU) 1 using the link 1 among multiple links and may receive a PPDU 2 using the link 2 among multiple links. On the other hand, if the MLD performs the STR operation when the band separation between multiple links is insufficient, in-device coexistence (IDC) interference, which is interference between the multiple links, may occur. Therefore, when the band separation between multiple links is not sufficient, the MLD may not be able to perform the STR operation. A link pair having the above-described interference relationship may be a non-simultaneous transmit and receive (NSTR) limited link pair. Here, the MLD may be an NSTR AP MLD or an NSTR non-AP MLD.

For example, a multi-link including a link 1, a link 2, and a link 3 may be configured between the AP MLD and the non-AP MLD 1. If the band separation between the link 1 and the link 3 is sufficient, the AP MLD may perform an STR operation using the link 1 and the link 3. In other words, the AP MLD may transmit a frame using the link 1 and may receive a frame using the link 3. If the band separation between the link 1 and the link 2 is not sufficient, the AP MLD may not be able to perform an STR operation using the link 1 and the link 2. If a band separation between the link 2 and the link 3 is not sufficient, the AP MLD may not be able to perform an STR operation using the link 2 and the link 3.

Meanwhile, in a wireless LAN system, a negotiation procedure for a multi-link operation may be performed in an access procedure between a STA and an AP.

A device (e.g., AP or STA) supporting a multi-link may be referred to as a multi-link device (MLD). An AP supporting a multi-link may be referred to as an AP MLD, and a STA supporting a multi-link may be referred to as a non-AP MLD or STA MLD. The AP MLD may have a physical address (e.g., MAC address) for each link. The AP MLD may be implemented as if an AP in charge of each link exists separately. A plurality of APs may be managed within one AP MLD. Accordingly, coordination between the plurality of APs belonging to the same AP MLD may be possible. The STA MLD may have a physical address (e.g., MAC address) for each link. The STA MLD may be implemented as if an STA in charge of each link exists separately. A plurality of STAs may be managed within one STA MLD. Accordingly, coordination between the plurality of STAs belonging to the same STA MLD may be possible.

For example, an AP1 of the AP MLD and a STA1 of the STA MLD may each be in charge of a first link and may communicate using the first link. An AP2 of the AP MLD and a STA2 of the STA MLD may each be in charge of a second link and may communicate using the second link. The STA2 may receive state change information for the first link in the second link. In this case, the STA MLD may collect information (e.g., state change information) received from each link and may control operations performed by the STA1 based on the collected information.

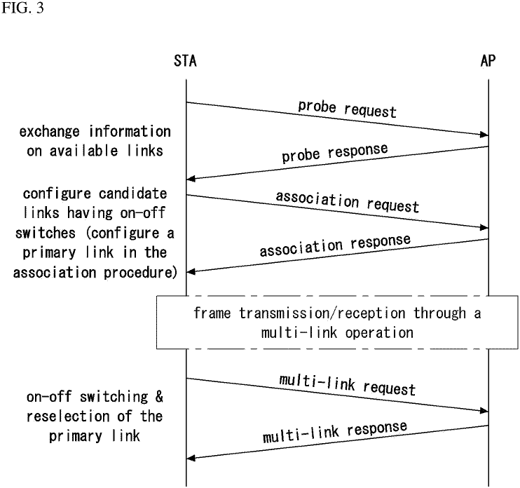

FIG. 3 is a sequence chart illustrating a first embodiment of a negotiation procedure for a multi-link operation in a wireless LAN system.

As shown in FIG. 3 an access procedure between an STA and an AP in an infrastructure basic service set (BSS) may generally be divided into a probe step of probing AP(s), an authentication step for authentication between the STA and the probed AP, and an association step of association between the STA and the authenticated AP.

In the probe step, the STA may detect one or more APs using a passive scanning scheme or an active scanning scheme. When the passive scanning scheme is used, the STA may detect one or more APs by overhearing beacons transmitted by the one or more APs. When the active scanning scheme is used, the STA may transmit a probe request frame and may detect one or more APs by receiving probe response frames that are responses to the probe request frame from the one or more APs.

When the one or more APs are detected, the STA may perform an authentication step with the detected AP(s). In this case, the STA may perform the authentication step with a plurality of APs. An authentication algorithm according to the IEEE 802.11 standard may be classified into an open system algorithm of exchanging two authentication frames, a shared key algorithm of exchanging four authentication frames, and the like.

The STA may transmit an authentication request frame based on the authentication algorithm according to the IEEE 802.11 standard and may complete authentication with the AP by receiving an authentication response frame that is a response to the authentication request frame from the AP.

When the authentication with the AP is completed, the STA may perform an association step with the AP. In particular, the STA may select one AP among AP(s) with which the STA has performed the authentication step and may perform the association step with the selected AP. In other words, the STA may transmit an association request frame to the selected AP and may complete the association with the AP by receiving an association response frame that is a response to the association request frame from the selected AP.

Meanwhile, a multi-link operation may be supported in the wireless LAN system. A multi-link device (MLD) may include one or more STAs affiliated with the MLD. The MLD may be a logical entity. The MLD may be classified into an AP MLD and a non-AP MLD. Each STA affiliated with the AP MLD may be an AP, and each STA affiliated with the non-AP MLD may be a non-AP STA. In order to configure a multi-link, a multi-link discovery procedure, a multi-link setup procedure, and the like may be performed. The multi-link discovery procedure may be performed in the probe step between an STA and an AP. In this case, multi-link information elements (ML IEs) may be included in the beacon frame, the probe request frame, and/or the probe response frame.

For example, in order to perform a multi-link operation, in the probe step, the AP (e.g., AP affiliated with an MLD) may exchange information indicating whether the multi-link operation can be used and information on available link(s) with the STA (e.g., non-AP STA affiliated with an MLD). In a negotiation procedure for the multi-link operation (e.g., multi-link setup procedure), the STA may transmit information of link(s) to be used for the multi-link operation. The negotiation procedure for the multi-link operation may be performed in the access procedure (e.g., association step) between the STA and the AP. Also, information element(s) required for the multi-link operation may be configured or changed by an action frame in the negotiation procedure.

In addition, in the access procedure (e.g., association step) between the STA and the AP, available link(s) of the AP may be configured, and an identifier (ID) may be assigned to each link. Thereafter, in the negotiation procedure and/or change procedure for the multi-link operation, information indicating whether each link is activated may be transmitted, and the information may be expressed using the link ID(s).

The information indicating whether the multi-link operation can be used may be transmitted and received in a procedure of exchanging capability information element(s) (e.g., EHT capability information element(s)) between the STA and the AP. The capability information element(s) may include information of supporting band(s), information of supporting link(s) (e.g., ID(s) and/or number of supporting link(s)), information of links capable of simultaneous transmission and reception (STR) operations (e.g., information on bands of the links, information on a separation between the links), and/or the like. In addition, the capability information element(s) may include information that individually indicates a link capable of the STR operation.

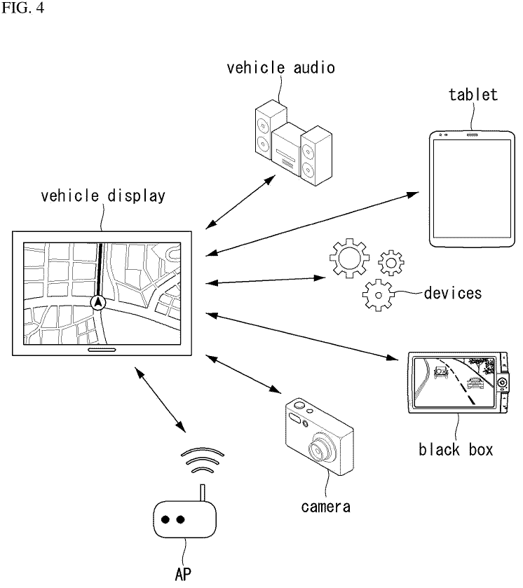

FIG. 4 is a conceptual diagram illustrating a first scenario in which direct communication is performed.

As shown in FIG. 4, a vehicle display device (or navigation device) associated with an AP may perform communications with other communication nodes (e.g., vehicle audio, tablet, devices, black box, camera, and the like). Here, the communication may be communication via the access point or direct communication. The direct communication may refer to peer-to-peer (P2P) communication. A communication node (e.g., vehicle display device) among the communication nodes associated with the access point, which directly communicates with another communication node, may be referred to as a ‘relay node’, ‘relay station’, or ‘relay STA’.

The relay station may obtain a direct communication period (e.g., transmission opportunity (TXOP)) by performing a negotiation procedure with the access point and may directly communicate with other station(s) in the direct communication period. The direct communication between the stations may be performed based on scheduling of the relay station. The scheduling operation for direct communication may be performed by considering that a station cannot receive a frame (e.g., data frame) transmitted from another station in one link while performing a transmission operation in the same link. The relay station may repeatedly transmit the received data in behalf of other station(s).

Another station performing direct communication with the relay station may be a station associated with the access point or a station not associated with the access point. A station not associated with the access point may perform direct communication after performing an association procedure with the relay station.

In order to discover station(s) (hereinafter, referred to as ‘peer station(s)’ with which the relay station will perform direct communication), the relay station may request the access point to provide information on the peer station(s). Alternatively, the relay station may transmit a probe request frame to discover peer station(s) and may identify the peer station(s) by receiving probe response frame(s) that is a response to the probe request frame. Here, the probe request frame transmitted from the relay station may be used to discover the peer station(s).

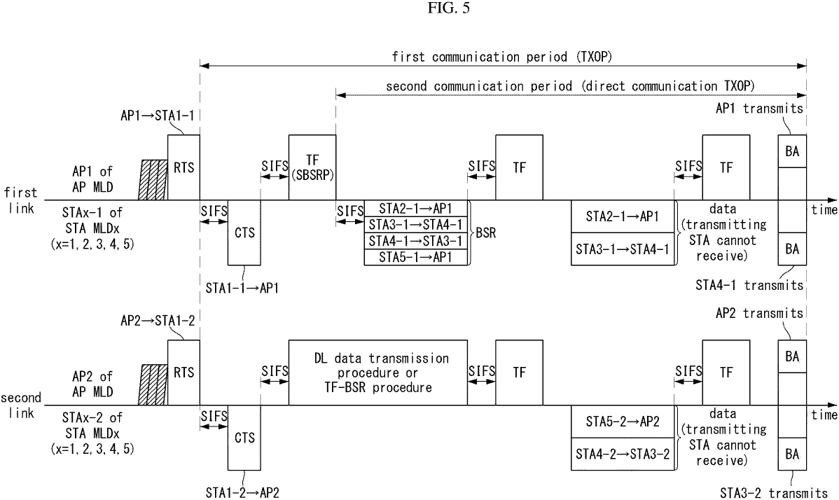

FIG. 5 is a timing diagram illustrating a first embodiment of a direct communication method in a wireless LAN system.

As shown in FIG. 5, an AP1 of an AP MLD and a STAx-1 of a STA MLDx may operate in a first link, and an AP2 of the AP MLD and a STAx-2 of a STA MLDx may operate in a second link. Here, x may be 1, 2, 3, 4, or 5, and each may indicate a different MLD. The AP MLD (e.g., AP1 and/or AP2) may perform channel access procedures in the first link and the second link to initiate direct communication. When the channel access procedures are completed, the AP MLD may transmit a first frame (e.g., request-to-send (RTS) frame) in the first link and the second link, respectively. In embodiments, the first frame may mean an RTS frame. The first frames may be transmitted simultaneously in the first link and the second link. The first frame may include an indicator indicating that direct communication is to be initiated (hereinafter, referred to as a ‘direct communication indicator’).

The direct communication indicator may be expressed by a receiver address (RA) field and a transmitter address (TA) field included in the first frame. When the RA field and the TA field included in the first frame are set to a MAC address of the AP MLD (or a MAC address of the AP1 or a MAC address of the AP2), this may indicate that direct communication is to be initiated. For example, the RA field and the TA field of the first frame transmitted in the first link may be set to the MAC address of the AP1, and the RA field and the TA field of the first frame transmitted in the second link may be set to the MAC address of the AP2. Although the address fields (e.g., RA field and TA field) of the first frame transmitted in the first link are set differently from the address fields of the first frame transmitted in the second link, since the STA MLDx knows the per-link address of the AP MLD (e.g., AP1 or AP2), the STA MLDx may know that the first frames have been transmitted from the same communication node (i.e., AP MLD).

A STA MLD1 may receive the first frame from the AP MLD and may determine that direct communication is to be initiated (or requested) based on the direct communication indicator (e.g., the values of the RA field and the TA field) included in the first frame. The STA MLD1 may determine whether to allow direct communication to be initiated by the AP MLD. When the direct communication is allowed, the STA MLD1 may transmit a second frame (e.g., clear-to-send (CTS) frame) to the AP MLD in the first link and the second link, respectively, in response to the first frame. In embodiments, the second frame that is a response to the first frame may mean a CTS frame. An RA field of the second frame transmitted in the first link may be set to the MAC address of the AP1 of the AP MLD, and an RA field of the second frame transmitted in the second link may be set to the MAC address of the AP2 of the AP MLD. When the second frame is received from the STA MLD1, the AP MLD may determine that direct communication has been initiated (e.g., allowed).

In the transmission/reception procedures of the first frame and the second frame (e.g., the transmission/reception operation of the RTS frame and the transmission/reception operation of the CTS frame), a first communication period that is a TXOP required for the entire communication may be configured. A value of a duration field included in a MAC header of the first frame (e.g., RTS frame) may be set to indicate the TXOP, and the TXOP may be configured when a second frame (e.g., CTS frame) that is a response frame to the first frame is transmitted and received. The TXOP may include a time required for transmission/reception operation(s) of one or more frames at a preset interval (e.g., SIFS) and a transmission/reception operation of an ACK frame for the corresponding frame(s). The AP MLD and the STA MLD1 may configured the TXOP, which is the first communication period, by performing the transmission/reception procedures of the first frame and the second frame.

The AP MLD may not know the STA performing direct communication and/or the size and receiver of data transmitted by the STA performing direct communication. In this case, the AP MLD may transmit a trigger frame requesting transmission of buffer status report(s) (BSR(s)) of STA(s) in one link (e.g., the first link) among multiple links. The trigger frame may be referred to as a TF. The trigger frame requesting BSR transmission may be a trigger frame for a scheduled buffer status report poll (SBSRP). Each of the STA(s) may receive the trigger frame from the AP1 in the first link and may transmit a BSR to the AP1 in the first link in response to the trigger frame. The BSR may include information on the size of data to be transmitted and information on a receiver for receiving the data.

While the trigger frame transmission operation and the BSR reception operation are performed in the first link, the AP2 of the AP MLD may transmit data stored in a buffer to STA(s) in the second link. Here, the STA(s) may be STA(s) participating in direct communication. The STA(s) may receive a data frame from the AP2 in the second link and may transmit a block ACK (BA) frame (or ACK frame) for the data frame to the AP2 in the second link. The AP2 may receive the BA frame from the STA(s) in the second link.

When an end time of the ‘TF-BSR procedure’ in the first link is different from an end time of the ‘data transmission procedure’ in the second link, padding may be used to match the end times. The TF-BSR procedure may include the transmission/reception operation of the trigger frame and the transmission/reception operation of BSR frames. The data transmission procedure may include the transmission/reception operation of the data frame and the transmission/reception operation of the BA frame (or ACK frame). A TF-BSR procedure may be performed instead of the data transmission procedure (e.g., DL data transmission procedure) in the second link. In this case, the same TF-BSR procedures may be performed in the first link and the second link. When the same TF-BSR procedures are performed in the first link and the second link, target STAs to transmit the BSR frame may be different for each link.

The AP MLD may identify the size of data existing in a buffer of each STA by performing the TF-BSR procedure. When a multi-user (MU)-orthogonal frequency division multiple access (OFDMA) scheme is used, a reception operation cannot be performed in one subchannel while a transmission operation is performed in another subchannel. For example, while a STA1 of the STA MLD1 performs direct communication with a STA2-1 of a STA MLD2 using a first subchannel of the first link, transmission of a STA3-1 of a STA MLD3 to the STA1 of the STA MLD1 using a second subchannel of the first link cannot be received by the STA1 of the STA MLD1. In this case, the AP MLD may schedule direct communications between the STA MLDs to be performed in different links. For example, the AP MLD may transmit a trigger frame including resource allocation information for transmission/reception operations of the STAs of the STA MLDs. If another STA MLD performs transmission to the STA MLD1 using another subchannel of the first link while the STA MLD1 is transmitting using a subchannel in the first link, the transmission of another STA MLD cannot be received by the STA MLD1. Accordingly, the AP MLD may transmit a trigger frame for scheduling the corresponding transmission operation so that another STA MLD may perform the transmission to the STA MLD1 using another link.

The direct communication between STAs may be performed without going through the AP. For example, a STA3-1 may directly transmit a data frame to a STA4-1 without going through the AP. In this case, a TA field of the frame transmitted by the STA3-1 may be set to a MAC address of the STA3-1, and an RA field of the frame transmitted by the STA3-1 may be set to a MAC address of the STA4-1.

For example, the STA MLD3 may have data to transmit to a STA MLD4, and the STA MLD4 may have data to transmit to the STA MLD3. The STA MLD(s) may not be able to perform a reception operation in a subchannel while performing a transmission operation in another subchannel according to the OFDMA scheme. Therefore, when a transmission operation of the STA MLD3 and a transmission operation of the STA MLD4 are allocated in the same link (i.e., when the STA3-1 performs transmission to the STA4-1 using a subchannel in the first link, and simultaneously with this operation, the STA4-1 performs transmission to the STA3-1 using another subchannel), direct communication between the STA3-1 and the STA4-1 may not be performed. The AP MLD may allocate resources so that a transmission operation from the STA MLD3 to the STA MLD4 is performed in the first link (i.e., the STA3-1 transmits a frame to the STA4-1), and a transmission operation from the STA MLD4 to the STA MLD3 is performed in the second link (i.e., a STA4-2 transmits a frame to a STA3-2). The AP MLD may also transmit a trigger frame including the resource allocation information.

The AP MLD may receive a data frame in any link when there is no data to transmit. The STA(s) may receive the trigger frame from the AP MLD (e.g., AP1 or AP2) and may identify the resource allocation information included in the trigger frame. The STA(s) may perform direct communication using the resource allocation information. When a resource allocated by the AP MLD is larger than a resource required for data transmission, padding may be added to the data so that the entire resource allocated by the AP MLD is used.

When the data frame transmission/reception operation (e.g., direct communication) is completed, the AP MLD may transmit a trigger frame to trigger transmission of a BA frame. The BA frame may use the same resource (e.g., the same subchannel) as the uplink resource. When the data frame(s) is received from the STA(s), the AP MLD may transmit a BA frame (or ACK frame) for the data frame(s). The trigger frame indicating a resource for transmission of the BA frame of the AP MLD may be transmitted from the AP MLD. The STA(s) may identify the resource (e.g., subchannel) to be decoded for reception of the BA frame by receiving the trigger frame from the AP MLD (e.g., AP1 or AP2).

In the direct communication procedure, the transmission operation of the BA frame by the STA(s) may be triggered by the trigger frame transmitted from the AP MLD. The STA(s) supporting multi-link operations may transmit the BA frame after a short interframe space (SIFS) from a reception time of the data frame without transmitting a trigger frame. The data frame and the BA frame may be transmitted/received in the same subchannel.

A partial period within the TXOP (e.g., first communication period) configured by the transmission/reception procedures of the first frame and the second frame may be configured as a direct communication period (e.g., direct communication TXOP or second communication period). The second communication period, which is the direct communication TXOP, may be configured by the trigger frame transmitted by the AP MLD. The value of the duration field included in the MAC header of the trigger frame for SBSRP (hereinafter referred to as ‘SBSRP trigger frame’) may be set to indicate (SIFS + transmission/reception time of the BSR + SIFS + transmission/reception time of the trigger frame + SIFS + transmission/reception time of the data frames between the STAs + SIFS + transmission/reception time of the trigger frame + transmission/reception time of the BA frame). The direct communication TXOP may be terminated within the TXOP configured by the transmission/reception procedures of the first frame and the second frame. The AP MLD may perform communications with other communication node(s) in a period from an end time of the direct communication TXOP to an end time of the TXOP configured by the transmission/reception procedures of the first frame and the second frame. When the TXOP is to be terminated early, the AP MLD may transmit a quality of service (QoS) null frame or a contention free (CF)-END frame including a duration field set to 0. When the QoS null frame or CF-END frame is transmitted, the TXOP configured by the transmission/reception procedures of the first frame and the second frame may be terminated early.

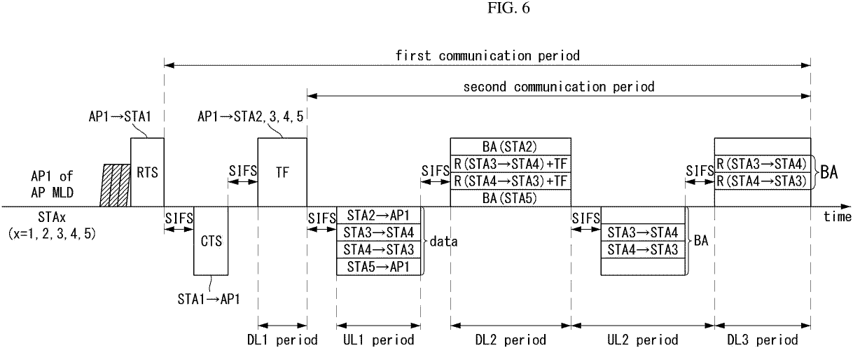

FIG. 6 is a timing diagram illustrating a second embodiment of a direct communication method in a wireless LAN system.

As shown in FIG. 6, direct communication may be performed between STAs that do not support STR operations. Alternatively, direct communication may be performed between STAs that cannot receive data transmitted in subchannel(s) while performing a transmission operation in other subchannel(s) according to the OFDMA scheme. The direct communication between the STAs may be performed without going through an AP. For example, a STA3 may directly transmit a data frame to a STA4 without going through an AP. In this case, a TA field of the frame transmitted by the STA3 may be set to a MAC address of the STA3, and an RA field of the frame transmitted by the STA3 may be set to a MAC address of the STA4.

An AP1 may perform a channel access procedure in a link to initiate direct communication. When the channel access procedure is completed, the AP1 may transmit a first frame to STA(s) in the link. The first frame may be an RTS frame or a data frame. The first frame may include a direct communication indicator. A STA (e.g., STA1) may receive the first frame from the AP1 and may determine that direct communication is to be initiated (or requested) based on the direct communication indicator included in the first frame. A partial time period within a TXOP configured by the transmission/reception operation of the first frame may be used as a period in which direct communication between STAs is performed. The STA may determine whether to allow direct communication to be initiated by the AP1 (i.e., whether a partial time period of the TXOP configured by the AP1 for the STA is allowed to be used for direct communication). When direct communication is allowed, the STA may transmit a second frame to the AP1 in response to the first frame. The second frame may be a CTS frame or an ACK frame. The AP1 may receive the second frame from the STA. If a value of a duration field included in a MAC header of the second frame corresponds to the TXOP requested by the AP1 (i.e., a value of a duration field included in the RTS frame), the AP1 may determine that the STA allows (e.g., approves) the direct communication.

In the transmission/reception procedures of the first frame (e.g., data frame or RTS frame) and the second frame (e.g., ACK frame or CTS frame), a first communication period that is a TXOP required for the entire communication may be configured. The value of the duration field included in the MAC header of the frame (e.g., RTS frame) may be set to indicate the TXOP, and when a response frame (e.g., CTS frame) to the above-described frame is transmitted/received, the TXOP may be configured. The TXOP may include a time required for transmission/reception operations of a plurality of frames at an interval of SIFS and a transmission/reception operation of a response frame (e.g., ACK or BA) within the maximum TXOP required for transmission of a plurality of frames by a TXOP holder who configures the corresponding TXOP. The AP1 and the STA may configure the TXOP by performing the data-ACK transmission/reception procedure or the RTS-CTS procedure.

The AP1 may transmit a trigger frame including resource allocation information for direct communication after a SIFS from a reception time of the second frame (e.g., ACK frame, BA frame, or CTS frame). The trigger frame may be used to inform one or more STAs participating in direct communication of a transmission time and/or transmission resources (e.g., time resources and/or frequency resources). The trigger frame may indicate that STAs indicated by the trigger frame start frame transmission operations using the allocated resources after a preset period (e.g., SIFS) from a reception time of the trigger frame. The trigger frame may include information indicating a second communication period that is a direct communication period (e.g., direct communication TXOP). The direct communication TXOP may be configured within the TXOP (e.g., the first communication period) configured by the transmission/reception procedures of the first frame (e.g., data frame or RTS frame) and the second frame (e.g., ACK frame or CTS frame).

Instead of the trigger frame, a multi user (MU) RTS frame designating a plurality of STAs or a modified MU RTS frame may be used. When an MU RTS frame is used, each of STA(s) receiving the MU RTS frame may transmit a CTS frame after a SIFS from a reception time of the MU RTS frame and may transmit a data frame after transmitting the CTS frame. The CTS frame may be a simultaneous CTS simultaneously transmitted by multiple terminals in the same frame format. The AP1 may transmit a trigger frame including resource allocation information for a STAx (e.g., resource allocation information for direct communication). Here, x may be 1, 2, 3, 4, or 5. The STA(s) may receive the trigger frame from the AP1 and may identify the resource allocation information included in the trigger frame. The STA(s) may transmit a data frame (e.g., a data frame for direct communication) in a resource (e.g., time and/or frequency resource) indicated by the resource allocation information. In the direct communication procedure, the data frame transmitted and received between the STAs may be referred to as a ‘direct communication data frame’.

An RA field of the direct communication data frame transmitted by the STA participating in the direct communication may not be set to the address of the AP1 that transmitted the trigger frame. The second communication period, which is a time resource (e.g., direct communication TXOP) allocated by the trigger frame, may be within the first communication period that is the TXOP configured by the transmission/reception procedures of the first frame (e.g., data frame or RTS frame) and the second frame (e.g., ACK frame or CTS frame). When the AP MLD does not support OFDMA STR operations and thus cannot receive data in subchannel(s) while transmitting in other subchannel(s) according to the OFDMA scheme, the AP MLD may not perform a reception operation while performing a transmission operation. Therefore, transmission resources may not be allocated after transmission of the trigger frame.

The AP1 may receive the direct communication data frame. In this case, the AP1 may repeatedly transmit the received direct communication data frame after a SIFS from an end time of the transmission/reception of the direct communication data frame. In other words, the direct communication data frame may be retransmitted by the AP1. Since the STA3 and the STA4 do not support OFDMA STR operations and thus cannot receive data in subchannel(s) while transmitting in other subchannel(s) according to the OFDMA scheme, the direct communication data frame transmitted from the STA3 may not be received by the STA4 performing the transmission operation, and the direct communication data frame transmitted from the STA4 may not be received by the STA3 performing the transmission operation. To solve this problem, the AP1 may transmit the direct communication data frame received from the STA3 to the STA4. This operation may be referred to as ‘R (STA3 → STA4)’. In addition, the AP1 may transmit the direct communication data frame received from the STA4 to the STA3. This operation may be referred to as ‘R (STA4 → STA3)’.

The operation ‘R (STA3 → STA4)’ may be performed when it is determined that the direct communication data frame transmitted from the STA3 is not received by the STA4. The operation ‘R (STA4 → STA3)’ may be performed when it is determined that the direct communication data frame transmitted from the STA4 is not received by the STA3. A trigger frame after the operation ‘R (STA3 → STA4)’ or ‘R (STA4 → STA3)’ may be a trigger frame for transmission resource allocation of a BA frame. The trigger frame may be a MU-RTS frame. A frame transmitted in the operation ‘R (STA3 → STA4)’ or ‘R (STA4 → STA3)’ may be generated as an aggregate (A)-MAC protocol data unit (MPDU) including the repeated direct communication data frame (e.g., the same data frame as the received frame) for retransmission of the direct communication data frame received by the AP1 and the TF for transmission resource allocation of the BA frame. In other words, the A-MPDU may include the repeated direct communication data frame and the TF.

In a DL2 period, the AP1 may retransmit the received direct communication data frame. Also, in the DL2 period, the AP1 may transmit a BA frame (or ACK frame) for the data frame received from other STA(s) in a UL1 period. The STA3 and STA4 that have not directly received the communication data frames in the UL1 period may receive the direct communication data frames from the AP1 in the DL2 period. In this case, the STA3 and the STA4 (e.g., STAs designated by the TF) may transmit a BA frame (or ACK frame) using a resource allocated by the TF.

The STA3 and STA4, which do not support the OFDMA STR operations and thus cannot receive data in subchannel(s) while transmitting in other subchannel(s) according to the OFDMA scheme, may not receive the BA frame in a UL2 period. In this case, in a DL3 period, the AP1 may transmit the BA frame received from the STA3 in the UL2 period to the STA4. This operation may be referred to as ‘R (STA3 → STA4)’. In the DL3 period, the AP1 may transmit the BA frame received from the STA4 in the UL2 period to the STA3. This operation may be referred to as ‘R (STA4 → STA3)’. In the DL3 period, the operation ‘R (STA3 → STA4)’ may be performed when it is determined that the BA frame transmitted from the STA3 is not received by the STA4. In the DL3 period, the operation ‘R (STA4 → STA3)’ may be performed when it is determined that the BA frame transmitted from the STA4 is not received by the STA3.

Meanwhile, direct communication between communication nodes (e.g., STAs) may be performed as follows. A first communication node may perform a channel access procedure and may transmit a first frame (e.g., RTS frame or data frame) to a second communication node when the channel access procedure is completed. A value of a duration field included in the first frame may indicate a first communication period (e.g., length of a first TXOP). The second communication node may receive the first frame from the first communication node and may transmit a second frame (e.g., CTS frame or BA frame) to the first communication node after a SIFS from a reception time of the first frame. The second frame may be a response frame to the first frame. The second communication node may identify the first communication period (e.g., TXOP) indicated by the first frame.

The first communication node may transmit, to a third communication node (or, a plurality of communication nodes), a third frame (e.g., trigger frame, MU RTS frame, or modified MU RTS frame) including a duration field indicating a second communication period (e.g.,, length of a second TXOP) within the first communication period (e.g., TXOP) after a preset period (e.g., (transmission/reception period of another data frame + SIFS) or SIFS) from a reception time of the second frame. A plurality of communication nodes including the third communication node may perform communications (e.g., direct communications) within the second communication period (e.g., TXOP). The second communication period (e.g., TXOP) may be a direct communication TXOP.

The second TXOP may be configured within the first communication period (e.g., TXOP). The length of the second communication period (e.g., TXOP) may be shorter than the length of the first communication period (e.g., TXOP). The third communication node may receive the third frame from the first communication node and may identify the second communication period (e.g., TXOP) indicated by the third frame. The third communication node may transmit a fourth frame (e.g., direct communication data frame) to a fourth communication node after a preset period (e.g., (transmission/reception period of a CTS frame + SIFS) or SIFS) from a reception time of the third frame. The fourth communication node may receive the fourth frame from the third communication node and may transmit a BA frame (or ACK frame) for the fourth frame to the third communication node. The transmission/reception operation of the fourth frame may be performed within the second communication period (e.g., TXOP).

The fifth communication node may transmit a fifth frame (e.g., direct communication data frame) after a preset period (e.g., (transmission/reception period of the BA frame for the fourth frame + SIFS) or SIFS) from an end time of the fourth frame. The fifth communication node may transmit a BA frame for the fifth frame after a preset period (e.g., SIFS) from a reception time of the fifth frame.

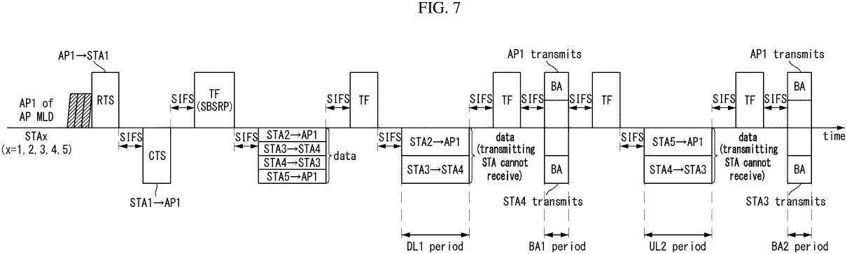

FIG. 7 is a timing diagram illustrating a third embodiment of a direct communication method in a wireless LAN system.

As shown in FIG. 7, direct communication may be performed between STAs that do not support the OFDMA STR operations and thus cannot receive data in subchannel(s) while transmitting in other subchannel(s) according to the OFDMA scheme. The AP1 may configure a direct communication period (e.g., direct communication TXOP) by performing a negotiation procedure with another communication node (e.g., STAx). Here, x may be 1, 2, 3, 4, or 5. The AP1 may identify buffer status(es) of the STA(s) and may configure a Type 1 group including STA(s) that supports OFDMA STR operations and thus can receive data in subchannel(s) while transmitting in other subchannel(s) according to the OFDMA scheme and a Type 2 group including STA(s) that do not support OFDMA STR operations and thus cannot receive data in subchannel(s) while transmitting in other subchannel(s) according to the OFDMA scheme. The AP1 may schedule communications for each of the Type 1 group and the Type 2 group.

The AP1 may transmit a first frame (e.g., data frame or RTS frame) including a direct communication indicator to initiate a direct communication procedure. The STA1 may receive the first frame from the AP1 and may determine that direct communication is to be initiated (or requested) based on the direct communication indicator included in the first frame. The STA1 may determine whether to allow direct communication to be initiated by AP1. When the direct communication is allowed, the STA1 may transmit a second frame (e.g., ACK frame or CTS frame) to the AP1 in response to the first frame. The second frame may indicate that a direct communication period is allowed. When the second frame is received from the STA1, the AP1 may determine that the entire TXOP direct communication has been initiated (e.g., allowed).

The AP1 may not know the STA performing direct communication and/or the size and target of data to be transmitted by the STA performing direct communication. In this case, the AP1 may transmit a trigger frame requesting transmission of BSR(s) of STA(s). The trigger frame requesting BSR transmission may be an SBSRP trigger frame. The SBSRP trigger frame may be an uplink OFDMA random access (UORA) trigger frame. Each of STA(s) participating in the direct communication may randomly select a subchannel (e.g., subchannel or subcarrier), and may transmit a BSR using the selected subchannel. All STAs participating in the direct communication may be requested, and all the STAs may transmit BSRs. The BSR may include information on the size of data to be transmitted and information on a receiver to receive the data.

The STA2 may have data to be transmitted to the AP1, the STA3 may have data to be transmitted to STA4, the STA4 may have data to be transmitted to the STA3, and the STA5 may have data to be transmitted to the AP1. A data frame in which an address of the AP1 that has transmitted the trigger frame is not set as a receiver address (RA) may be a direct communication data frame. When a transmission operation of ‘STA3 → STA4’ and a transmission operation of ‘STA4 → STA3’ are performed in the same time period, the STA3 may not receive a data frame from the STA4, and the STA4 may not receive a data frame from the STA3. When the AP1 did not make a BSR request and thus does not know receivers of data frames transmitted by the STAs through direct communication, the AP1 may receive the data transmitted directly between the STAs and may identify data transmitted between the STAs not supporting STR operations using different frequencies in the same time period. For example, when the STA3 and the STA4 are STAs that do not support STR operations and the STA3 transmits data to the STA4 using a first frequency in the same time period, the AP1 may identify that the STA4 transmits data to the STA3 using a second frequency. The AP1 may retransmit the received data on behalf of the STAs in a different time period. For example, the data transmitted by the STA1 to the STA2 may be retransmitted by the AP1 in a first time period, and the data transmitted by the STA2 to the STA1 may be retransmitted by the AP1 in a second time period. The STAs may receive the retransmitted data in a time period different from the transmission period. For example, in a UL1 period, the data from the STA3 to the STA4 may be transmitted using a first frequency resource (e.g., subchannel or link), and in the same time period, the data from the STA4 to the STA3 may be transmitted using a second frequency resource (e.g., subchannel or link). In this case, when the STA3 and the STA4 do not support STR operations, the AP1 may retransmit the received data after a SIFS period. The retransmitted data may be transmitted using the same frequency resource as the frequency resource used by the STA (e.g., subchannel or link).

In order to prevent this problem, the transmission operation of ‘STA3 → STA4’ and the transmission operation of ‘STA4 → STA3’ may be performed in different time periods.

For example, the transmission operation of ‘STA2 → API’ and the transmission operation of ‘STA3 → STA4’ may be scheduled to be performed in the UL1 period, and the transmission operation of ‘STA5 → API’ and the transmission operation of ‘STA4 → STA3’ may be scheduled to be performed in the UL2 period. When the transmission operations are completed in the UL1 period, the AP1 may transmit a trigger frame including allocation information of a BA1 period for transmission and reception of a BA frame. When the transmission operations are completed in the UL2 period, the AP1 may transmit a trigger frame including allocation information of a BA2 period for transmission and reception of a BA frame. When there is a data frame and/or a BA frame to be transmitted in the above-described period, the AP1 may transmit a trigger frame including resource allocation information for transmitting the data frame and/or the BA frame. The STA(s) may receive the trigger frame from the AP1 and may receive the data frame and/or the BA frame from the AP1 in a resource indicated by the resource allocation information included in the trigger frame. The AP1 may enable other terminals to receive the BA frame by including the allocation information in the trigger frame even though it is a BA frame transmitted by the AP1 itself. The trigger frame may include an AP identifier to be used for a resource allocated by the AP to itself, and the corresponding AP identifier may be a reserved association ID (AID) that is not allocated to the STAs. Alternatively, the trigger frame may include information indicating a resource that is not allocated to any STAs, and the AP may transmit a BA frame by using a resource (e.g., a resource not allocated to any STAs) indicated by the trigger frame.

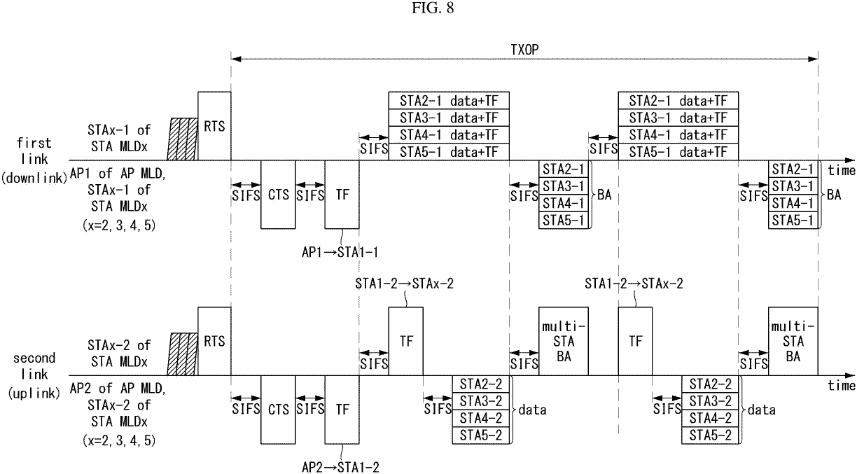

FIG. 8 is a timing diagram illustrating a fourth embodiment of a direct communication method in a wireless LAN system.

Referring to FIG. 8, in the direct communication procedure, a downlink transmission operation may be separated from an uplink transmission operation. When multiple links are available, a first frame (e.g., RTS frame) including a duration field indicating a direct communication TXOP (e.g., direct communication period) may be transmitted in multiple links. A first communication node (e.g., STA MLD1) may transmit the first frame in two or more links and may receive, from a second communication node (e.g., AP MLD), a second frame (e.g., CTS frame) that is a response to the first frame in at least one of the two or more links. The link in which the second frame is received may be a link in which direct communication is possible. When the first communication node is the STA MLD1, the second communication node may be the AP MLD. Alternatively, when the first communication node is the AP MLD, the second communication node may be the STA MLD1.

In order to initiate a direct communication procedure, a STA1-1 may transmit a first frame (e.g., RTS frame) including a direct communication indicator and information indicating a TXOP (e.g., direct communication TXOP) in the first link, and a STA1-2 may transmit a first frame (e.g., RTS frame) including a direct communication indicator and information indicating a TXOP (e.g., direct communication TXOP) in the second link. The AP MLD (e.g., AP1 and AP2) may receive the first frames in the first link and the second link and may identify the direct communication indicator and the TXOP (e.g., direct communication TXOP) included in the first frame. The AP MLD may determine whether to allow direct communication requested by the first frame. When the direct communication is allowed, the AP MLD may transmit a second frame (e.g., CTS frame) in the first link and the second link. The second frame may indicate that the direct communication (e.g., direct communication TXOP) is allowed.

The AP MLD may transmit a trigger frame to the STA MLD1 corresponding to a transmitter address (TA) of the first frame for direct communication. The transmission operation of the trigger frame may be omitted. Instead of the trigger frame, a MU RTS frame or a modified MU RTS frame may be used. When a MU RTS frame is used, direct communication may be performed after transmission/reception of a CTS frame in response to the MU RTS frame. Alternatively, when a MU RTS frame is used, direct communication may be performed without transmitting/receiving a CTS frame.

An OFDMA non-STR (NSTR) MLD that does not support OFDMA STR operations and thus cannot receive data in subchannel(s) while transmitting in other subchannel(s) according the OFDMA scheme may perform a downlink operation and an uplink operation independently in multiple links. An OFDMA multi-user downlink operation may be performed in one link, and an OFDMA multi-user uplink operation may be performed in another link. When uplink data does not exist and downlink data exists, a communication node (e.g., NSTR MLD) may perform a monitoring operation in one link on which a downlink operation is performed. The first link may be a link in which a downlink operation is performed, and the second link may be a link in which an uplink operation is performed.

The STA MLD1 may receive the trigger frame for direct communication from the AP MLD, may use the first link for the OFDMA multi-user downlink operation and may use the second link for the OFDMA multi-user direct communication uplink operation. The OFDMA multi-user direct communication downlink operation may be a transmission operation of ‘STA1-1 → STAx-1’, and the OFDMA multi-user direct communication uplink operation may be a transmission operation of ‘STAx-2 → STA1-2’. Here, x may be 2, 3, 4, or 5. The STA MLD1 (e.g., STA1-1) may perform communication (e.g., direct communication) using the OFDMA scheme. The STA1-1 may transmit data frames to a plurality of STAs based on a frequency multiplexing scheme. In this case, a trigger frame including resource allocation information of a BA frame may be transmitted together with the data frame. The trigger frame may be aggregated with the data frame in the form of an A-MPDU, and the aggregated frame (e.g., trigger frame + data frame) may be transmitted. Alternatively, the trigger frame may be transmitted after a preset interval from a transmission time of the data frame. The interval between the end time of the data frame and a start time of the trigger frame may be xIFS or more. xIFS may be a SIFS, distributed coordination function (DCF) interframe space (DIFS), point coordination function (PCF) interframe space (PIFS), or arbitration interframe space (AIFS). The STAx-1 may receive the data frame and the trigger frame from the STA1-1. The STAx-1 may transmit a BA frame for the data frame to the STA1-1 in a resource indicated by the trigger frame.

The STA1-2 may transmit a trigger frame for the OFDMA multi-user direct communication uplink operation. The trigger frame may include information indicating the STAx-2 performing the OFDMA multi-user direct communication uplink operation and resource allocation information for the uplink operation. The STAx-2 (e.g., STAx-2 indicated by the trigger frame) may transmit a data frame to the STA1-2 using a resource allocated by the trigger frame. The STA1-2 may receive the data frame from the STAx-2 and may transmit a multi-STA BA frame including information on a reception state of the data frame.

An end time of the OFDMA multi-user direct communication downlink operation and an end time of the OFDMA multi-user direct communication uplink operation may be configured to be the same. In order to make the end time of the OFDMA multi-user direct communication downlink operation the same as the end time of the OFDMA multi-user direct communication uplink operation, padding may be used. The STA(s) participating in the direct communication may perform only a downlink operation when an uplink operation is not required. The uplink operation may be used for transmission of feedback information (e.g., short packet). The above-described operation may be suitable for TCP operations. In TCP operations, many packets (e.g., data) may be transmitted in one transmission direction, and few packets (e.g., ACK) may be transmitted in another transmission direction.

When there are many packets (e.g., data) to be transmitted in another communication node other than the STA MLD1, the another communication node may perform the above-described role of the STA MLD1. For example, the another communication node may initiate a direct communication procedure. Even when the above-described OFDMA multi-user transmission scheme is not used, the downlink operation and the uplink operation may be equally performed in two communication nodes. When direct communication is performed between the STA MLD1 and the STA MLD2, the first link may be used for a transmission operation of ‘STA1-1 of STA MLD1 → STA2-1 of STA MLD2’, and the second link may be used for a transmission operation of ‘STA2-2 of STA MLD2 → STA1-2 of STA MLD1’. In the one-to-one direct communication procedure, the data frame may be transmitted without transmission of a trigger frame.

The embodiments of the present disclosure may be implemented as program instructions executable by a variety of computers and recorded on a computer-readable medium. The computer-readable medium may include a program instruction, a data file, a data structure, or a combination thereof. The program instructions recorded on the computer-readable medium may be designed and configured specifically for the present disclosure or can be publicly known and available to those who having ordinary skill in the field of computer software.

Examples of the computer-readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above hardware device can be configured to operate as at least one software module in order to perform the embodiments of the present disclosure, and vice versa.

While the embodiments of the present disclosure and their advantages have been described in detail, it should be understood that various changes, substitutions, and alterations may be made herein without departing from the scope of the present disclosure.

1. An operation method of an access point in a wireless local area network (LAN) system, the operation method comprising:
transmitting, to a first station, a first frame to configure a first communication period, the first frame including information on a time of the first communication period;
receiving, from the first station, a second frame that is a response frame to the first frame, and configuring the first communication period;
after receiving the second frame, transmitting a third frame to a second station to configure a second communication period within the first communication period, the third frame including information on a time of the second communication period;
identifying that the second station transmits a fourth frame using a resource allocated by the third frame, the fourth frame being a direct communication frame transmitted to a third station that is not the access point; and
identifying that the third station transmits a reception response frame for the fourth frame.

2. The operation method according to claim 1, further comprising:
identifying that the second station transmits a fifth frame using a resource allocated by the third frame within the second communication period after a predetermine time elapses from a transmission completion time of the reception response frame, the fifth frame being a direct communication frame transmitted to a fourth station that is not the access point; and
identifying that a reception response frame for the fifth frame is transmitted.

3. The operation method according to claim 1, wherein a direct communication period is configured as the second communication period within the first communication period, the second communication period being indicated by a duration field included in the third frame.

4. The operation method according to claim 1, wherein the third frame is a trigger frame or a multi-user (MU) request-to-send (RTS) frame.

5. The operation method according to claim 1, wherein the third frame further includes resource allocation information, and the fourth frame is transmitted and received in a resource indicated by the resource allocation information.

6. The operation method according to claim 1, wherein a frame transmission/reception operation between the second station and the third station during the second communication period is performed based on a short interframe space (SIFS) without performing a channel access procedure.

7. An access point in a wireless local area network (LAN) system, comprising:
a processor; and
a memory storing one or more instructions executable by the processor,
wherein the one or more instructions are executed to:
transmit, to a first station, a first frame to configure a first communication period, the first frame including information on a time of the first communication period;
receive, from the first station, a second frame that is a response frame to the first frame and configure the first communication period;
after receiving the second frame, transmit a third frame to a second station to configure a second communication period within the first communication period, the third frame including information on a time of the second communication period;
identify that the second station transmits a fourth frame using a resource allocated by the third frame, the fourth frame being a direct communication frame transmitted to a third station that is not the access point; and
identify that the third station transmits a reception response frame for the fourth frame.

8. The access point according to claim 7, wherein the one or more instructions are further executed to:
identify that the second station transmits a fifth frame using a resource allocated by the third frame within the second communication period after a predetermine time elapses from a transmission completion time of the reception response frame, the fifth frame being a direct communication frame transmitted to a fourth station that is not the access point; and
identify that a reception response frame for the fifth frame is transmitted.

9. The access point according to claim 7, wherein a direct communication period is configured as the second communication period within the first communication period, the second communication period being indicated by a duration field included in the third frame.

10. The access point according to claim 7, wherein the third frame is a trigger frame or a multi-user (MU) request-to-send (RTS) frame.

11. The access point according to claim 7, wherein the third frame further includes resource allocation information, and the fourth frame is transmitted and received in a resource indicated by the resource allocation information.

12. The access point according to claim 7, wherein a frame transmission/reception operation between the second station and the third station during the second communication period is performed based on a short interframe space (SIFS) without performing a channel access procedure.
